(19) United States
(12) Patent Application Publication
(10) Pub. No.: US 2016/0145404 A1
(43) Pub. Date: May 26, 2016

(54) POLYMER FOAM AND USE THEREOF IN HOLLOW BODIES

(71) Applicant: SIKA TECHNOLOGY AG, Baar (CH)

(72) Inventors: Herbert ACKERMANN, Tann (CH); Andreas BRUNNER, Rafz (CH); Frank HOEFFLIN, Baden (CH)

(73) Assignee: SIKA TECHNOLOGY AG, Baar (CH)

(21) Appl. No.: 14/775,460

(22) PCT Filed: Mar. 12, 2014
(86) PCT No.: PCT/EP2014/054768

§ 371 Date: Sep. 11, 2015

(30) Foreign Application Priority Data
Mar. 12, 2013 (EP) 13158828.7

(51) Int. Cl. C08J 9/00; B29C 44/24; B29C 47/00; C08J 9/14

(52) U.S. Cl. CPC C08J 9/0061; C08J 9/0066; C08J 9/0028; C08J 9/141; B29C 44/24; B29C 47/0042; C08J 2325/06; C08J 2371/12; C08J 2371/08; C08J 2203/14; B29K 2025/06

(57) ABSTRACT

A polymeric foam is described which can be obtained by extrusion of a composition comprising a) a polymer blend of polystyrene, polyphenylene oxide and/or polyphenyl ether, b) at least one blowing agent, and c) at least one nucleating agent, as well as the use thereof for the filling of hollow bodies, in particular in the form of a window or door profile, with foam. The invention also relates to foam-filled hollow bodies, extrudates, and a method for producing the polymeric foam.

### TECHNICAL FIELD

The invention relates to a polymeric foam which is particularly suitable for filling hollow spaces and hollow bodies with foam. Furthermore, the invention relates to a foam-filled hollow body which is filled with the polymeric foam and a coextrudate, wherein the polymeric foam is a component thereof. Finally, the invention also relates to a method for producing a hollow body filled with the polymeric foam.

### PRIOR ART

In recent years the window and door industry had to adapt in order to meet new requirements in terms of improved thermal insulation of windows and doors. This is reflected, inter alia, in increasingly stringent guidelines, which provide the window manufacturers and their suppliers with ever greater challenges.

To satisfy these requirements, for example, profiles filled with two-component polyurethane foams are proposed, which can be welded and wherein the hollow spaces of finished profiles are filled with polyurethane foam. For this purpose, both polyurethane components are injected with help of long syringes under high pressure into the hollow spaces of the profile, and foamed. The problem with these systems is, however, that for polyurethanes it is not easy to realize a complete reaction of the isocyanate monomers. This has implications for the subsequent processing of corresponding window profiles, as residual isocyanate monomers may be released while trimming and customizing the profiles. To prevent this, additional safety measures must be taken and expensive insurance policies must be taken out. In addition, the polyurethane components must be stored on site and during storage attention must be paid to the avoidance of exposure to these compounds. Finally, two-component polyurethane systems have the drawback that they have to be classified in a worse flammability rating due to possible free isocyanate.

In an alternative approach, expanded polystyrene foam bodies were first made outside of the window profile and then inserted into a profile.

For example, EP 0296408 A1 describes extruded foams of polyphenylene ether/polystyrene mixtures with low density and high compressive strength. These foams are prepared by mixing the starting materials with a blowing agent, for example, chlorinated or fluorinated hydrocarbons, that is insoluble in the starting materials in an extruder. Subsequently, the mixture is extruded, with the material expanding into a foam body.

U.S. Pat. No. 4,598,101 describes foams having a density of less than 20 lbs/ft³ based on polyphenylene ether/polystyrene mixtures which are foamed with help of chlorinated solvents such as dichloromethane, chloroform or 1,1,2-trichloroethane. The use of chlorinated or fluorinated solvents is associated with considerable drawbacks due to the release of these solvents into the atmosphere and their toxicity.

A solution to this problem is found in EP 0937741 A1 which provides for the use of a mixture of low-boiling ethers such as dimethyl ether and water as blowing agent. According to EP 0937741 A1, this blowing agent mixture provides an improved foam density, foam strength and surface shape. The blowing agent mixture can be used, inter alia, to foam polyphenylene ether/polystyrene mixtures.

Methods for producing expandable granules are also known from the prior art. For instance, EP 0377115 A2 describes polyphenylene/polystyrene resin mixtures with low odor, which are foamed by using chlorofluorocarbons as blowing agents. The resin granules according to EP 0377115 A2 are produced by cooling an extrusion mixture of resin and blowing agent below the softening point of the resin and processing the mixture to form a granulate.

EP 0305862 A1 also describes a similar method for producing expandable granules for polyphenylene/polystyrene resin mixtures. Overall, a two-stage method as described above has, however, the drawback that the production of foam-filled profiles is associated with a considerable effort and that the production of exactly fitting foam bodies requires additional equipment.

WO 2009/062986 A1 suggests a solution to this problem, according to which a foamable material is introduced into the cavity of the profile in the form of granules during the extrusion of a PVC profile. Through contact with the still hot profile, a blowing agent contained in the granules is activated resulting in a foaming of the material in the still hot PVC profile. In this method, it is necessary that the foam is incompatible with the plastic material of the profile, because it would otherwise result in an undesired adhesion of the foam to the plastic material. A problem with this approach is, however, that the cavity in the profile cannot be completely filled with compositions consisting essentially of a foamable base polymer and a blowing agent, since foaming occurs only upon contact with a surface of the hollow profile. As a result, in some instances the profile frame cannot be filled evenly.

Another problem occurring during foaming within an extruded and thus still hot profile is that especially thin profile walls can be severely deformed during expansion of the foam. Finally, a drawback of existing foam compositions is that the foam contracts again during cooling, so that a complete filling of the cavity is difficult to ensure and voids form that increase the thermal conductivity of the profile.

Accordingly, it is known to insulate cavities with foam. Basically, depending on the geometric configuration of the cavity or hollow body to be insulated and the processing characteristics of the material used, the foam can be inserted into the hollow body or cavity as a separately pre-compacted part, and introduced at the application site in a non-expanded initial state and then expanded, especially foamed. Both basic procedures are known for producing insulation material-filled window or door profiles. Either an independent profile is made from the corresponding insulating material which is introduced into the prefabricated frame profile, or starting material is injected into the frame profile and expanded after a corresponding activation. A method of the latter type is described in WO 2009/062986 A1 mentioned above. Therein it is suggested also to activate the expandable starting material for the formation of the insulating material that fills the profile through the heat released by the plastic frame profile which is extruded virtually simultaneously. In particular from the perspective of a window or door manufacturer, both solutions have drawbacks. In particular, in the first variant these drawbacks are of a logistical nature, and in the second variant sophisticated methods of plastics technology must be executed in their own facility and the corresponding equipment must be available.

EP 0265788 B1 describes a method for producing expanded particles made of polyphenylene ether resin compositions of low density, wherein the polyphenylene ether resin is mixed with up to 98 wt.-% of an alkylene-aromatic resin, based on the weight of the two resins taken together. This method is characterized in that a blowing agent is present in the resin composition and that the particles of the resin composition are expanded with saturated steam. However, this method and the resulting particles have the drawback that relatively expensive starting compounds are used. Furthermore, the resulting particles as so-called connecting sleeves provide no advantages over the less expensive expanded polystyrene.

WO 2011/062632 A1 describes the foaming of polyvinylchloride. However, the density of the foam thus obtained is not satisfactory.

### PRESENTATION OF THE INVENTION

The object according to the invention is to overcome the above drawbacks, in particular to provide a polymeric foam, which is constituted such that it fills the cavity as evenly as possible without deforming the profile walls significantly, and does not contract significantly during cooling. During the production of plastic profiles it should also be possible to introduce the polymeric foam directly into the still hot extruded profiles, for example, by direct co-extrusion, and thus to provide an inexpensive alternative to the subsequent “insertion” of preformed foam in the profile. Furthermore, good insulation should be made possible and any adhesion to the profile which otherwise would be unfavorable in terms of recyclability should be avoided, if possible.

This object is achieved by a polymeric foam according to claim 1. This polymeric foam can be obtained by extrusion of a composition comprising a) a polymer blend of polystyrene, polyphenylene oxide and/or polyphenyl ether, b) at least one blowing agent and c) at least one nucleating agent. The essence of the invention consequently lies the use of a special composition that is converted into the polymeric foam according to the invention by extrusion.

In a preferred embodiment, the polymer blend is a polymer blend of polystyrene and polyphenylene oxide.

In a further preferred embodiment, the polymer blend is a polymer blend of polystyrene and polyphenyl ether.

Finally, a polymer blend of polystyrene, polyphenylene oxide and polyphenyl ether is a further preferred embodiment of the invention.

The three polymers (polystyrene, polyphenylene oxide and polyphenyl ethers) that can be used in the polymer blend are completely miscible in one another. The polymer blend has only one glass transition temperature T_{g}, preferably in the range of about 110° C. to 210° C., particularly preferably in the range of about 140° C. to about 170° C. By varying the individual components or their proportions in the polymer blend, the T_{g} can be set to the desired value.

The glass transition temperature T_{g} was determined as follows:
Method: DMA (Dynamic Mechanical Analysis)
Instrument: Mettler Toledo DMA/SDTA861^{e}
Deformation mode: shear
Implementation: Temperature scanning at a fixed frequency; 30-250° C. with 5° C./min heating rate measured at a frequency of 1 Hz. Maximum deflection (amplitude) was 10 micrometers and maximum load amplitude was 0.1 N
T_{g} was determined from the maximum (peak) of the loss factor tan(d); d=delta.

In a preferred embodiment, the glass transition temperature T_{g} is adjusted to the extrusion temperature. Adjusting means that the glass transition temperature T_{g} is about 20° C. to 40° C., preferably about 30° C. to 40° C., below the extrusion temperature.

The use of the polymer blend leads to the advantage that the rheological properties of the composition may be adjusted such that the foaming behavior is advantageous in the given process conditions, for example, an extrusion temperature of about 200° C., compared with previously used formulations.

In a preferred embodiment, the composition which is extruded to form polymeric foam is loaded with a blowing agent prior to extrusion. Furthermore, it is preferred that the nucleating agent is also added to the composition to be extruded prior to extrusion. For example, the EPS products (Expandable Polystyrene) from Synbra Technology by, in particular their HT EPS products (High Temperature Expandable Polystyrene), can be used if at least one nucleating agent is added thereto. Preferred products are HT EPS 600, HT EPS 800 and HT EPS 1000, all available from Synbra Technology by. The products of Synbra Technology by are those products that were commercially available on Oct. 23, 2012.

That is, preferably the polymer matrix is not melted first and the blowing agent is added in a second step before the material is extruded directly to form the foam, but rather the loading of the composition with blowing agents and/or nucleating agents is carried out already before extrusion.

The polymer blend usually constitutes the major component of the composition, the proportion of which preferably is about 50 to 95 wt.-%, based on the total composition. Particularly preferably, the content of the polymer blend is in the range of about 70 to 95 wt.-%.

The proportion of the polyphenylene oxide and/or the proportion of polyphenylene ether is preferably from about 40 to 80 wt.-%, in particular up to about 60 wt.-%, based on the polymer blend.

The at least one blowing agent may be a physical and/or chemical blowing agent. The use of a physical blowing agent is preferred, since this has, as compared with nitrogen and carbon dioxide, which are usually formed in chemical blowing agents, an improved solubility in the polymer matrix; this is particularly true for the short-chain alkanes, such as propane, butane, pentane, heptane and octane. Furthermore, because of its molecular size, the use of a physical blowing agent leads to improved thermal conductivity and the diffusion rate of the gas molecules through the polymer is reduced, so thereby the volume can be kept better, i.e., less shrinkage occurs. Another advantage of using a physical blowing agent is the elimination of the complex reactions and the known side effects (for example, additional energy input) which are associated with chemical blowing agents.

As a physical blowing agent known physical blowing agents can be used; it is, however, advantageous if the physical blowing agent is a hydrocarbon, preferably selected from the group comprising pentane, heptane, octane, nonane, and/or decane and their isomers. HFC gases such as, for example, Formacel 1100 from DuPont, may be used also. Overall, the use of halogenated hydrocarbons is, however, less preferred, so that in a preferred embodiment the blowing agent in the composition according to the invention consists of hydrocarbons.

In a particularly preferred embodiment the physical blowing agent is a mixture of n-pentane and iso-pentane. Preferably, n-pentane and iso-pentane are used in a ratio of about 3:1 to about 4:1.

The proportion of the physical blowing agent is about 2 to 15 wt.-%, preferably about 3 to 10 wt.-%, and particularly preferably about 5 to 9 wt.-%, based on the total composition.

A chemical blowing agent can also be used instead of the physical blowing agent. The chemical blowing agent is preferably selected from the group comprising azodicarbonamides, sulfohydrazides, bicarbonates and/or carbonates. The chemical blowing agent is used preferably in an amount of about 5 to 20 wt.-%, particularly preferably in an amount of about 12 to 16 wt.-%, based on the total composition.

The composition from which the polymeric foam according to the invention is obtained by extrusion comprises at least one nucleating agent in addition to the polymer and the at least one blowing agent. The at least one nucleating agent is preferably selected from the group comprising CaCO₃ (chalk), talc, carbon black, graphite, titanium dioxide and/or at least one chemical blowing agent (as defined above). That is, a chemical blowing agent can be used also as a nucleating agent. However, it is only used when the at least one blowing agent is a physical blowing agent, rather than a chemical blowing agent. In this case the chemical blowing agent contributes to a small extent to the expansion.

The use of the at least one nucleating agent improves the foam structure.

CaCO₃ (chalk) is preferably used in an amount of up to about 15 wt.-%, based on the total composition. Talc is preferably used in an amount of up to about 7 wt.-%, based on the total composition. If a chemical blowing agent is used as a nucleating agent, then this is used preferably in an amount of up to about 1.5 wt.-%, particularly preferably up to about 1.0 wt.-%, based on the total composition. Carbon black, graphite and/or titanium dioxide are preferably used in an amount of up to about 5 wt.-%, based on the total composition.

The composition from which the polymeric foam according to the invention is obtainable by extrusion may contain other conventional constituents. For example, at least one flame retardant, at least one heat reflector, at least one heat loss additive, at least one antioxidant and/or at least one anti-condensation additive may be present. The flame retardant is preferably aluminum trihydrate, hexabromocyclododecane, tetrabromobisphenol A and/or polybrominated diphenyl ether. Practical heat reflectors are carbon black, graphite and/or titanium dioxide, which, as mentioned above, can also be used as nucleating agents. Suitable antioxidants are for example sterically hindered phenols. Preferably, the composition may also be coated with at least one surface antistatic agent.

In a preferred embodiment, the composition from which the polymeric foam according to the invention is obtainable by extrusion comprises
a) at least about 70 wt.-% of a polymer blend of polystyrene, polyphenylene oxide and/or polyphenyl ether,
b) about 5 to 9 wt.-% of a physical blowing agent, and
c) about 1 to 6 wt.-% of at least one nucleating agent.

It is critical that the polymeric foam according to the invention is obtained by extrusion of the above-described composition. The foam formation by extrusion has several advantages over the use of foam formation by means of steam. Thus, by means of steam, moldings can be produced only in a batch process and not in a continuous process. By means of steam no endless bodies can be obtained. In addition, no pre-foaming and aging, which requires several process steps, are necessary by extrusion. Also, the polymeric foam according to the invention, which is obtained by extrusion of the above-described composition, is obtainable in a less energy-intensive and hence a more cost-effective manner. Finally, the blowing agent in the polymeric foam according to the invention remains longer included compared to known particle foams, resulting in improved insulation. The extrusion provides a continuous and homogeneous strand.

The extrusion can be carried out in a conventional extrusion apparatus. The temperature should be between 50 and 350° C., preferably between 80 and 220° C. The pressure ratios should be at least about 30 bar, particularly preferably about 50 bar. Preferably, the extrusion apparatus has a nozzle geometry such that there is a sudden pressure drop at the exit of the extrusion. The pressure drop is preferably adjusted to the rheological properties of the polymeric foam. A pressure drop of greater than about 30 bar, preferably greater than about 40 bar, to ambient pressure, i.e., 1 bar, in less than 1 second, preferably in less than 0.5 seconds and particularly preferably in less than 0.25 seconds, is particularly advantageous. The faster the pressure drop, the better is the foam structure. In order to obtain such an abrupt pressure drop, an appropriately configured nozzle can be used. Examples of such nozzles can be found in FIGS. 5A and 5C.

Particularly preferred devices are described below and shown in the figures, wherein the part of the device, which concerns the fusion of the thermoplastically processable plastic material, is omitted here.

In a preferred embodiment, the polymeric foam according to the invention has a density of 15-100 kg/m³, preferably 20-60 kg/m³ and particularly preferably 25-30 kg/m³.

The polymeric foam according to the invention also preferably has a thermal conductivity of <0.04 W/(mK), an expansion of 1000%, in particular of 2000%, and/or a weldability at 240 to 260° C. for about 80 s. In the weldability of the polymeric foam, it is critical that during welding of PVC profiles, which are filled with polymeric foam for example, no residue remains on the welding plate. Accordingly, welding should not cause any weakening of the mechanical and optical properties. The use of Teflon-coated welding plates is particularly preferred. In addition, the polymeric foam is preferably characterized by at least one further property listed hereinafter:
Recyclability
Minimal shrinkage behavior
No bending of webs in the profile or deformation of chambers of the profile
No reduction of the corner strength
Water absorption analogous to PVC
Gas release during expansion is harmless
No or only minimal damage of PVC during the foaming process
No material build-up in the tool or tool attachment
Odorless
Heat stable over long periods of time
No special work or storage instructions for the profile manufacturer.

In a particularly preferred embodiment, the polymeric foam has all of the aforementioned properties.

A further aspect of the present invention relates to a hollow body with a cavity into which the polymeric foam according to the invention is introduced. The hollow body with a cavity is preferably window or door profiles. Further, it is preferred if the cavity in which the polymeric foam according to the invention has been introduced is completely filled with said polymeric foam.

Plastic profiles can advantageously also be produced by a method wherein a composition as described above is introduced and foamed in at least one of the cavities of the profile during the extrusion of the profile.

In the extrusion of hollow bodies having cavities, in particular windows, there are relatively high temperatures. These temperatures also differ depending on the processor. For a foam extrusion, it is therefore advantageous that the material properties be adjusted to these relatively high temperatures. With the above-described composition from which the polymeric foam according to the invention is obtainable by extrusion, it is possible to adjust to the temperatures required. This can be achieved by varying the components of the polymer blend and in particular by varying the ratios of polystyrene, polyphenylene oxide and/or polyphenyl ether. The present invention therefore leads to the advantage that the composition from which the polymeric foam according to the invention is obtainable can be foamed at high extrusion temperatures, for example at temperatures of 160 to 210° C. and particularly preferably from 180 to 200° C.

The present invention also relates to a method for producing a hollow body or cavity that is foamed with the above-mentioned polymeric foam as an insulating material, wherein a composition comprising a) a polymer blend of polystyrene, polyphenylene oxide and/or polyphenylene ether, b) at least one blowing agent, and c) at least one nucleating agent, is fed to an extrusion apparatus, is activated therein under pressure, and upon discharge therefrom into the hollow body or the cavity is expanded with such high volume expansion gradients that the insulation material formed by the expansion is filling the cross section of the hollow body or cavity instantaneously, preferably completely, upon entry. For preferred and optional further ingredients of the composition, reference is made to the above explanations.

In a preferred embodiment, a certain pressure is already present prior to activation, so as to prevent premature foaming. This is particularly advantageous with the use of physical blowing agents. In this context, the pressure should be already generated at the point at which the composition from which the polymeric foam according to the invention is obtainable, has not yet melted. This is possible, for example, in that the screw configuration in the extruder is designed such that the flight depth of the screw prior to melting is in the range of about the size of the composition from which the polymeric foam according to the invention is obtainable by extrusion.

Further, it is advantageous that the extrusion rate of the plastic material and the composition from which the polymeric foam according to the invention is obtainable by extrusion are matched to one another. This is especially true since the degree of expansion is preferably controlled by the amount of blowing agent.

In one embodiment of the method according to the invention it is provided that solid starting material in granule form is fed to the plastic extrusion apparatus of an extruder or injection molding machine type. Solid, granular starting material can be formulated, stored and processed with little residue easily and cost-effectively, and offers significant advantages over liquid or paste formulations.

In one embodiment, which is of particular importance from a current perspective under environmental aspects as well as economically, the hollow body is a profile extruded of a plastic material, and the insulation material is introduced in a co-extrusion process simultaneously with the formation of the plastic profile, preferably a polyvinyl chloride-based plastic profile, into the plastic profile. Basically, the invention can be used also with extruded metal profiles for window and door frames and in addition in other types of products, such as for in-situ sealing of joints or insulation of cavities in building structures or for joint sealing and insulation of profiles or other cavities in vehicle, aircraft and ship building. The introduction of the insulating material into the profile is advantageously carried out such that it fills the respective cavity virtually immediately, preferably substantially completely. The cavity may be the chamber of a single-chamber profile or a chamber of a multi-chamber profile, wherein one or more remaining chambers may well be free from insulation material.

In a further embodiment of the invention it is provided that a plastic extrusion apparatus with at least one conveyor screw is used and that the plastic extrusion apparatus is configured and the mechanical properties of the starting material are predetermined such that high pressures and/or shear forces occur, which prevent premature foaming of the material and/or at least contribute to a thermal activation of the starting material. In this embodiment, it may be possible that an additional means of heating the plastics extrusion apparatus may not be required, which is particularly energy-saving. In another embodiment, a plastic extrusion apparatus with a heating means is used and the heating means is operated such that it at least contributes to thermal activation of the starting material. A combination of both ways of activation of the starting material is possible also.

In a further embodiment of the invention, the expansion process of the starting material is controlled by a special nozzle geometry during discharge from the extrusion apparatus. Nozzle geometries that are adjusted to the application and tailored to the special insulation material (or the starting material thereof) enable precise control of the expansion process, and the implementation in an add-on part of the actual extrusion apparatus enables the provision of various adjusted nozzle geometries and the rapid and cost-effective change during production changeovers, whether through use of a different insulating material or other profile geometries, etc.

In a special embodiment firstly a gradual reduction in cross section with a small gradient over a great length, then a holding constant of the cross section over a small length and then a gradual reduction in cross section with a large gradient over a small length is realized, before the discharge into the hollow body or cavity occurs. Instead of the last step or also subsequent thereto, a gradual increase in cross section with a medium gradient over medium length and finally an exit through a spray head with a plurality of spray holes can be realized. Particularly preferred embodiments are shown in FIGS. 5A and 5C. This subdivision of the nozzle into sections is an advantageous realization from a current perspective; however, it should be noted that not necessarily all of said sections with said respective phases having said associated geometric characteristics have to be present. It is important, however, that an abrupt pressure drop occurs at the exit.

It is advantageous when the interspace which is formed during the filling of profile with the foam right at the nozzle can be vented or degassed (degassing) by means of an additional feeding through the tool. This feeding may be fitted also with an adjustable pressure valve. This prevents the build-up of excessive negative or positive pressure in the space between profile chamber and foam, which can lead to an undesirable deformation of the plastic profile. The invention also relates to the hollow body or cavities contained in the above-mentioned methods.

A further aspect of the present invention relates to a method for the extrusion of two (polymeric foam and plate/plate profile) and/or three components (sandwich panels), wherein the polymeric foam according to the invention described above is used. Here, the polymeric foam can be made adherent by means of suitable additives, such as, for example, low molecular weight, aliphatic or aromatic hydrocarbons with a comparatively high T_{g} (tackifier), such that a solid and stable bond between the plastic profile and polymeric foam is formed. In this context, the polymeric foam may be extruded directly “in air”, i.e., without contact with an outer boundary as in the case of the cavities. This results in further applications, such as, for example, sidings, which are used mainly in building construction for façade building. Here, the polymeric foam according to the invention acts as a thermal insulation layer.

### DESCRIPTION OF THE DRAWINGS

Additional advantages and practicalities of the invention will become apparent by way of the following figures. Of which:

FIG. 1 shows a schematic representation for explaining an embodiment of the method according to the invention in the form of a representation in longitudinal section through a co-extrusion arrangement,

FIG. 2 shows sketch-like cross-sectional representations of a simple profile geometry and of nozzle cross-sections of a plastic extrusion apparatus according to embodiments of the invention,

FIGS. 3A and 3B show schematic representations (representation in longitudinal section) with a graphical representation of an associated pressure profile (FIG. 3A) and cross-sectional representations taken along a sectional plane in FIG. 3A (FIG. 3B) for explaining another embodiment of the invention,

FIGS. 4A and 4B show schematic representations (representation in longitudinal section) with a graphical representation of an associated pressure profile (FIG. 4A) and cross-sectional representations taken along a sectional plane in FIG. 4A (FIG. 4B) for explaining another embodiment of the invention,

FIGS. 5A and 5B show schematic representations (representation in longitudinal section) with a graphical representation of an associated pressure profile (FIG. 5A) and cross-sectional representations taken along a sectional plane in FIG. 5A (FIG. 5B) for explaining another embodiment of the invention,

FIGS. 5C and 5D show schematic representations of a another embodiment,

FIGS. 6A to 6D show representations in longitudinal section and a plan view, respectively, of an add-on part of a plastic extrusion apparatus according to another embodiment of the invention, and

FIGS. 7A and 7B show a representation in longitudinal section and a perspective view, respectively, of an add-on part of a plastic extrusion apparatus according to another embodiment of the invention.

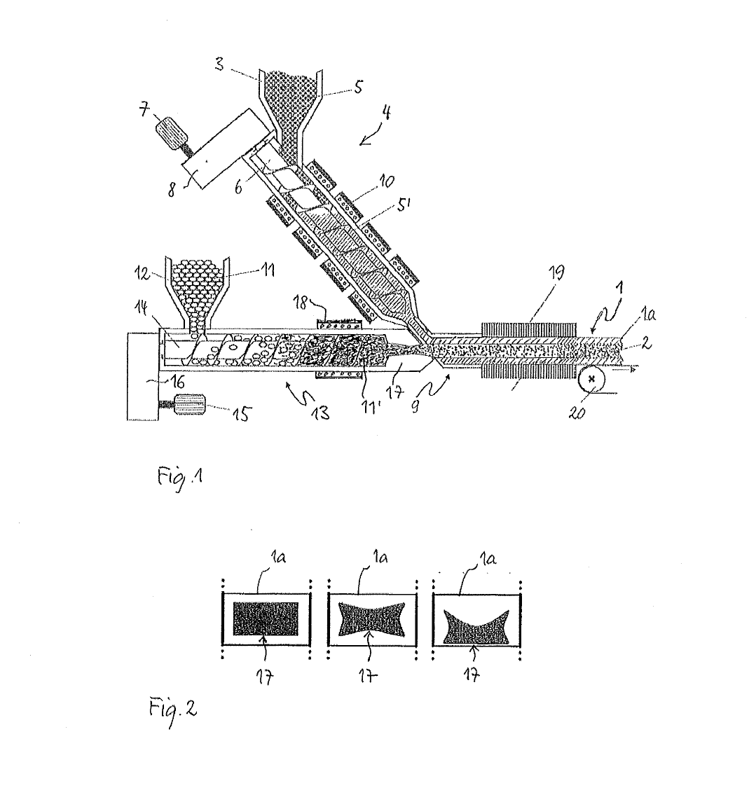

FIG. 1 shows schematically a co-extrusion process according to the invention for producing plastic profiles 1 with a foamed insulation core 2.

In this case, the hopper 3 of a first extruder 4 is filled with a solid, thermoplastically processable plastic material 5. This plastic material can be present in any form. In particular, the plastic material is present as granules or as a powder. The plastic material is preferably extruded at a temperature of 150° C. to 350° C., in particular from 170° C. to 260° C., preferably from 180° C. to 220° C. The plastic material 5 enters into the interior of the first extruder 4 through hopper 3. Here, the plastic material is conveyed in the direction of a nozzle 9 by means of a screw conveyor 6 which is driven by a motor 7 via a transmission 8, and at the same time it is heated from outside to a temperature above its melting point by heating elements 10, which are attached to the first extruder, whereby the plastic material melts. The molten plastic material 5′ is pressed through nozzle 9, which has approximately the cross sectional shape of the profile to be produced.

In parallel, foamable material 11, that is, the composition described above, in particular in the form of granules, is filled into hopper 12 of a second extruder 13, and then enters into the inside of the second extruder through said hopper 12. The foamable material 11 is conveyed in the direction of a nozzle 17 by means of a screw conveyor 14, which is driven by a motor 15 via a transmission 16. Thereby, high pressures and shear forces are generated in a targeted manner by a suitable geometrical configuration of the screw and the screw cylinder which lead to a softening and an activation of the originally solid granules, and an additional heating means 18 provided supports this process.

At nozzle 17, the activated foamable material 11′ is coextruded with almost sudden expansion, which is controlled by a special geometrical configuration of the nozzle, into the cavity of the plastic hollow profile 1a, where it comes into contact with the inner walls of the plastic hollow profile. Introducing the plastic profile 1 in a calibration means 19 is intended to ensure that the plastic hollow profile is not deformed by the pressure of the foamed material until the plastic material has solidified, rather it retains its predetermined cross-sectional shape. This applies in particular to the external walls.

After the calibration means 19, plastic profile 1 optionally passes through a separate cooling means where it enters for example a water bath or it is sprayed by water showers. At the end of the co-extrusion process, the plastic profile 1 is pulled off at a constant rate that is matched to the conveying capacity of the extruders, via a pull-off means 20.

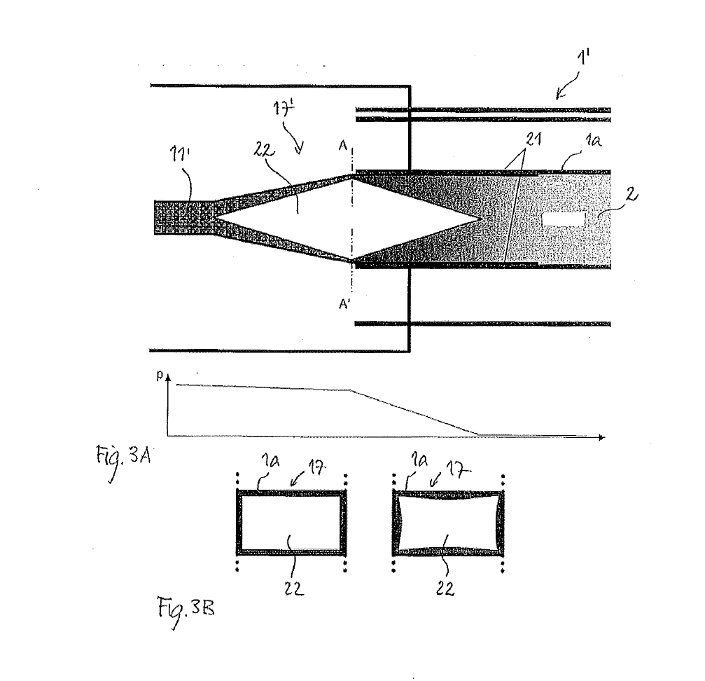

Embodiments and aspects of the method according to the invention and an extrusion apparatus usable for this purpose are explained below with reference to FIGS. 2-7B. Where appropriate, reference is made to parts shown in FIG. 1, and these are designated by the reference numerals of FIG. 1 or reference numerals based thereon.

FIG. 2 shows in three schematic cross sectional representations the wall 1a of a plastic profile that is rectangular in cross-section with examples of cross-sectional shapes of a press forming section of nozzle 17 of the second extruder according to FIG. 1. In the representation on the left, the cross-sectional shape of nozzle 17 corresponds to that of the profile. In order to achieve an improved filling of such a profile in the corner regions, modifications of the cross-sectional shape of the nozzle are suggested which are apparent from the representations in the middle and on the right side. Common to both is a constriction of the nozzle shape in the middle areas of the boundary surfaces, or, in other words, a butterfly-like widening toward the corner sections.

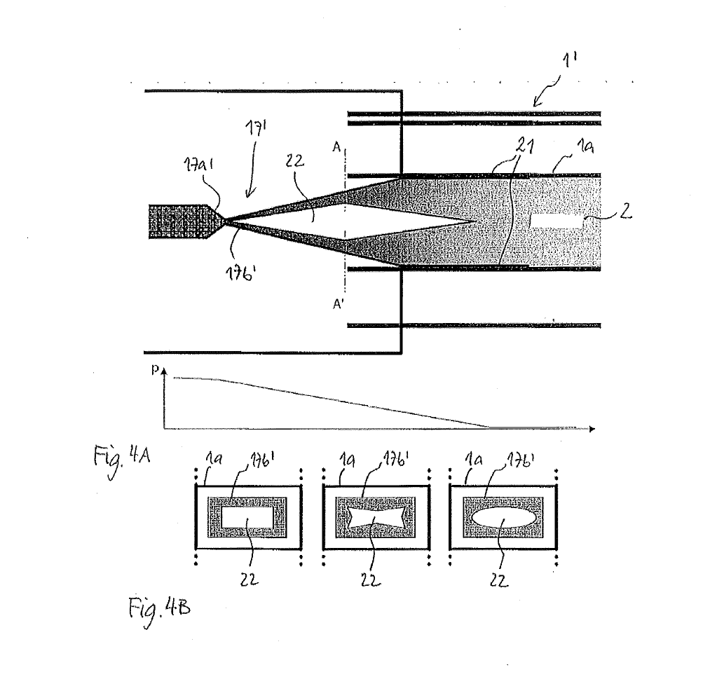

FIGS. 3A and 3B show exemplary geometries of a discharge nozzle 17 in schematic longitudinal and cross-sectional representation along with a plastic profile 1′ which is subdivided into a plurality of chambers and which has an insulating core 2 in a chamber 1a. Here, in addition, steel baffles 21 are provided at the exit of the nozzle for the lateral boundary of the expanding insulating material even after leaving the nozzle and to reduce its adhesion to the profile wall. In the nozzle itself a nozzle or injection core (mandrel) 22 is provided for pre-molding the shape in which the activated starting material 11′ expands to form the finished insulation material 2. In FIG. 3A it can be seen that the nozzle core 22 has a double-conical shape in longitudinal extension, and FIG. 3B shows as a cross-sectional representation taken along the section plane A′ in FIG. 3A two different cross-sectional shapes (based on the left and middle variant in FIG. 2). The graphical representation in the lower part of FIG. 3A shows the pressure profile at the exit of the extrusion apparatus.

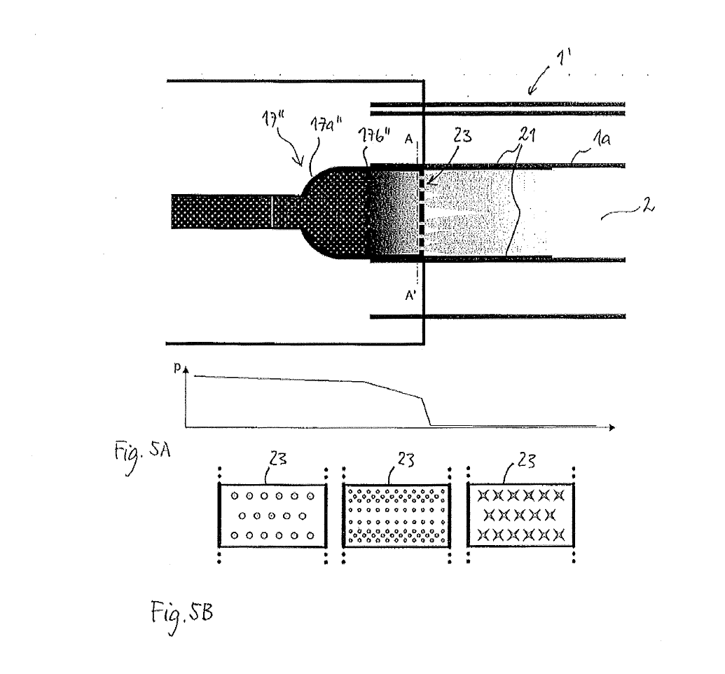

FIGS. 4A and 4B show a similar arrangement of nozzles as shown in FIGS. 3A and 3B in connection with the same plastic profile 1′. The main differences are that nozzle core 22 here is substantially smaller dimensioned in its central dimensions, and nozzle 17′ (in addition to a first section of constant diameter that is not designated separately) comprises a constriction section 17a′ with an adjacent widening section 17b′, wherein the slim nozzle core 22 sits in the latter. In the lower part of FIG. 4A, in turn, the pressure profile is shown, and FIG. 4B shows three examples of cross-sectional geometries of nozzle 17′ and of nozzle core 22 along the sectional plane A′. Thus, the cross-section of the nozzle core is here either rectangular or butterfly-shaped or elliptical, which can achieve different effects in terms of filling the plastic profile with the insulation material.

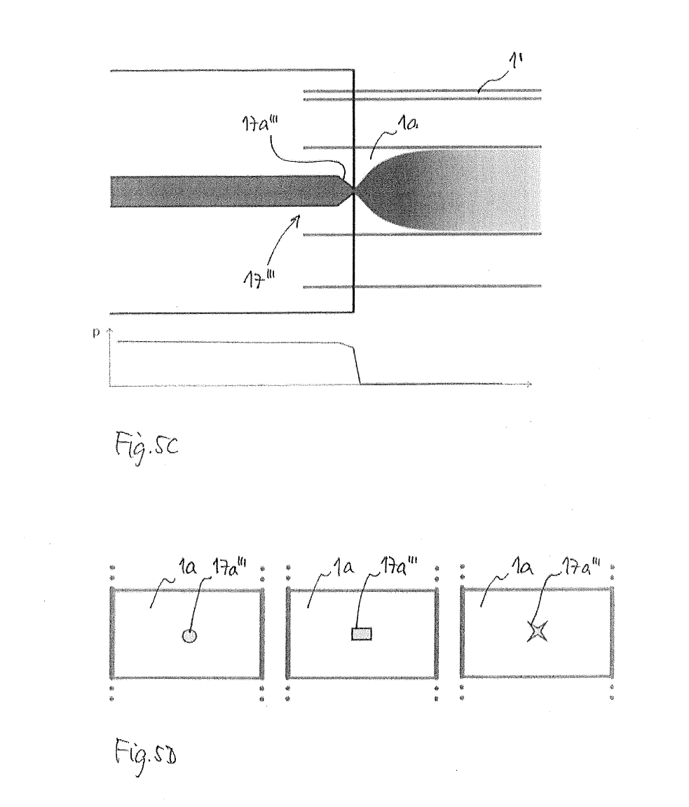

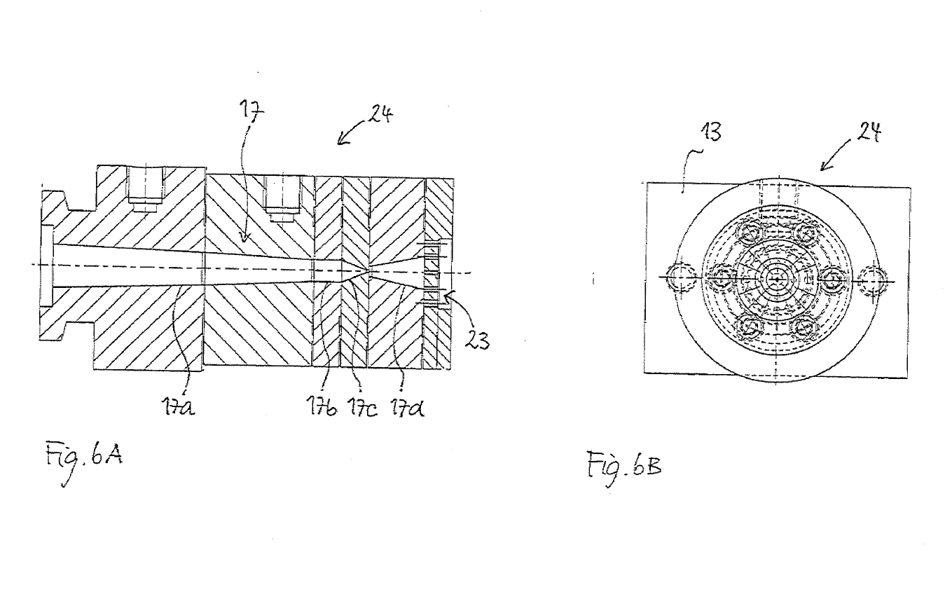

As a fundamentally different embodiment, FIGS. 5A and 5B show a nozzle 17″ of an extrusion apparatus which discharges the expanding insulation material through an aperture plate (strainer) 23, again in conjunction with the plastic profile 1′, which has already been shown in FIGS. 3A and 4A. In addition to the feed section of constant diameter, nozzle 17″ comprises here an approximately hemispherical widening section 17a″ which transitions into a cylindrical section 17b″ of a larger diameter. At its end, and thus directly at the exit of nozzle 17″ sits aperture plate 23, for which three different realizations are shown in FIG. 5B. The representation on the right is different from the other two in that the openings of the aperture plate are designed not circular in cross-section, but star-shaped.

As a further embodiment, FIG. 5C shows a nozzle 17′″ that comprises a constriction section (a section with linearly rapidly decreasing diameter) 17a″ and in this regard corresponds to nozzle 17′ of FIG. 4A. However, in the present embodiment, no nozzle core is present, rather the insulation material 2 exiting from constriction section 17a′″ expands without central guiding into central chamber 1a of plastic profile 1′, which has the same shape as in the embodiment of FIGS. 3A and 3B. The diagram in the lower part of the figure shows that the pressure drop here is faster than in the embodiment of FIGS. 3A and 3B. FIG. 5D shows a synoptic representation of some nozzle cross sections (cross-sections of the end of constriction section 17a′″), in relation to the wall of central profile chamber 1a.

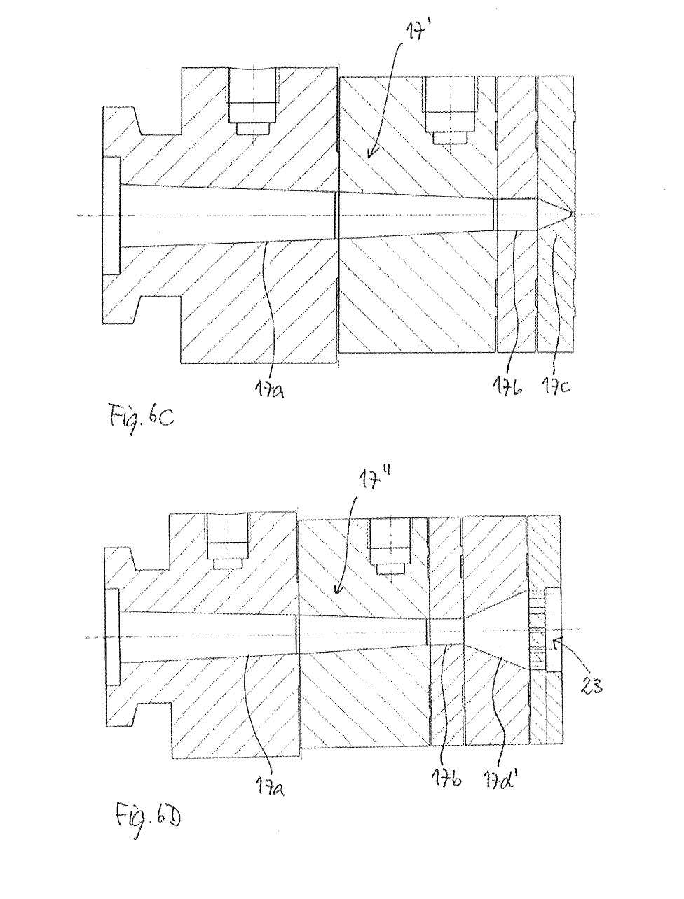

FIGS. 6A and 6B show a special nozzle assembly of the extrusion apparatus, which is implemented in an add-on part 24 to be inserted at the exit of the apparatus. In FIG. 6A, it can be seen that the nozzle arrangement has a first nozzle section 17a of great length, in which the nozzle cross-section decreases continuously with small pitch, a second nozzle section 17b of short length, in which the cross-section remains constant, a third nozzle section 17c of short length in which the nozzle cross-section decreases with large pitch, a fourth nozzle section 17d of medium length, in which the nozzle cross-section increases with medium pitch, and a fifth nozzle section 23 having a plurality of spray holes. Furthermore, it can be seen that for the implementation of these nozzle sections the add-on part 24 is subdivided into a plurality of individual (not separately designated) plates, wherein the first nozzle section 17a is implemented by two longitudinally joined plates or base bodies. This modular design enables relatively easy variations of the nozzle geometry in certain sections without having to make a new add-on part 24 as a whole.

FIGS. 6C and 6D show further embodiments of a particular nozzle assembly for shaping the insulating-material flow in the extrusion apparatus. In any case, in both embodiments, nozzle sections 17a and 17b are identical in terms of function and identical with the embodiments according to FIGS. 6A and 6B. In nozzle 17′ of FIG. 6C, a section 17c, in which the width of the insulation material-discharge channel decreases with high gradient, follows nozzle section 17b with a constant width—just as in the embodiment of FIG. 6A. The narrow end of nozzle section 17c in this embodiment is also the discharge opening of the nozzle. In nozzle 17″ of FIG. 6D, however, a nozzle section 17d′ with increasing diameter directly follows nozzle section 17B with constant width, and a strainer 23 is attached thereto. In this respect the embodiment of FIG. 6D resembles that of FIG. 6A, except that here the narrowing nozzle section on the entry side of the widening nozzle section 17d′ no longer exists, and the end section of the widening nozzle section is chosen such that discharged insulation material passes through all openings of strainer 23.

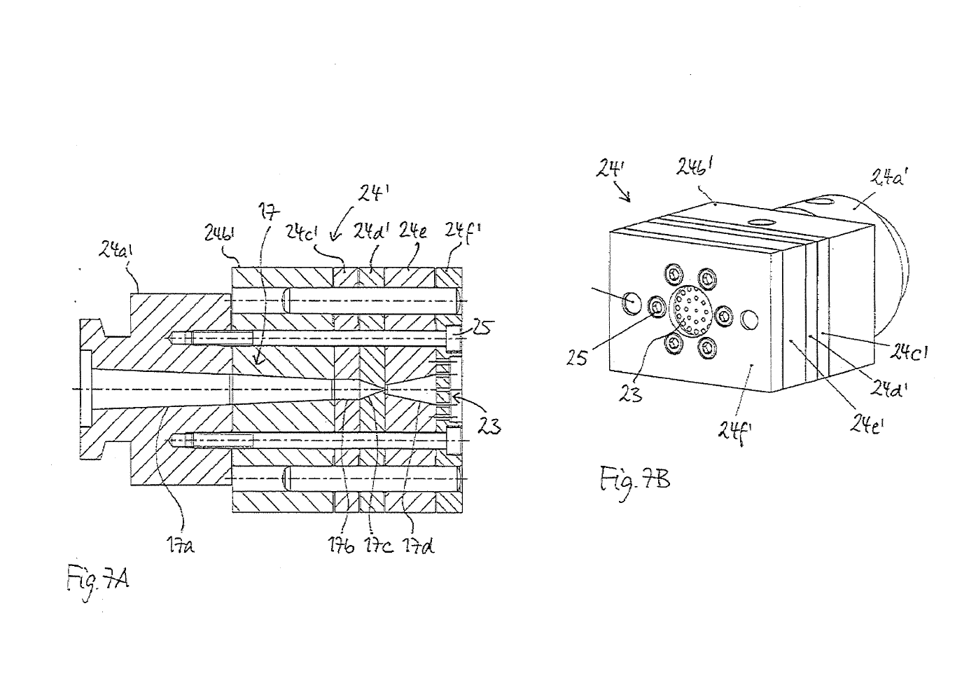

FIGS. 7A and 7B show an add-on part 24′ which, compared with the embodiment described above, has been modified, and which is designed to be placed on the exit of extrusion apparatus 13. With this add-on part 24′ the same geometry of the nozzle arrangement 17 is realized as in FIG. 6A, in principle, so that the nozzle sections are designated with the same reference numerals as in that case. In FIGS. 7A and 7B, the modules that make up add-on part 24′ are designated with numbers 24a′ to 24f′, and the mounting bolts 25 for mounting the modules are also designated.

### LIST OF REFERENCE NUMERALS

1, 1′ Plastic profile
1a Plastic hollow profile
2 Insulation core, insulation material
3 Hopper
4 (first) Extruder
5, 5′ Plastic material
6, 14 Conveyor screw
7, 15 Motor
8, 16 Transmission
9, 17; 17′; 17″; 17′″ Nozzle
10, 18 Heating elements/means
11, 11′ Foamable material (granules)
12 Hopper
13 (second) Extruder
17a to 17c; Nozzle sections
17a′, 17b′, 17d′
17a″, 17b″; 17a′″
19 Calibration means
20 Pull-off means
21 Baffles
22 Nozzle or injection core
23 Aperture plate (strainer)
24; 24′ Add-on part
24a′-24f′ Modules of the add-on part
25 Mounting bolts

### EXAMPLES

Different foams were prepared using an extruder. The tested foams contained a polymer blend of polystyrene and polyphenylene oxide/polyphenyl ether, a blowing agent and a nucleating agent. The blowing agent used was a mixture of n-pentane and iso-pentane. The blowing agent is already contained in the HT EPS products used. Azodicarbonamide (samples 1 and 3) and talc (samples 2 and 4) were used as the nucleating agent. The tested compositions are shown in the following Table 1:

TABLE 1

| | Sample 1 | Sample 2 | Sample 3 | Sample 4 |
|---|---|---|---|---|
| HT EPS 600 | 99 | 96 | 99 | 96 |
| Nucleating agent | 1 | 4 | 1 | 4 |

Identical experiments were carried out also with HT EPS 800 and HT EPS 1000.

The resulting foams are characterized by a fine and very regular foam structure. They also exhibit a slight shrinkage after extrusion. These characteristics were determined by visual inspection.

1. A polymeric foam obtainable by extrusion of a composition comprising
a) a polymer blend of polystyrene, polyphenylene oxide and/or polyphenyl ether,
b) at least one blowing agent, and
c) at least one nucleating agent.

2. The polymeric foam according to claim 1, wherein the polymer blend has a glass transition temperature T_{g} (measured as specified in the description) of from about 110° C. to about 210° C., preferably from about 140° C. to about 170° C.

3. The polymeric foam according to claim 1, wherein the proportion of the polymer blend is from about 50 to 95 wt.-%, preferably about 70 to about 95 wt.-%, based on the total composition.

4. The polymeric foam according to claim 1, wherein the proportion of the polyphenylene oxide and/or the proportion of the polyphenyl ether is about 40 to 80 wt.-%, preferably up to about 60 wt.-%, based on the polymer blend.

5. The polymeric foam according to claim 1, wherein the blowing agent is at least one physical and/or at least one chemical blowing agent, preferably at least one physical blowing agent.

6. The polymeric foam according to claim 5, wherein the proportion of the physical blowing agent is about 2 to 15 wt.-%, preferably about 3 to 10 wt.-%, and particularly preferably about 5 to 9 wt.-%.

7. The polymeric foam according to claim 1, wherein the at least one nucleating agent is selected from the group comprising CaCO₃ (chalk), preferably in an amount of up to about 15 wt.-%, based on the total composition, talc, preferably in an amount of up to about 7 wt.-%, based on the total composition, chemical blowing agents, preferably in an amount of up to about 1.5 wt.-%, carbon black, graphite and/or titanium dioxide, preferably in an amount of up to about 5 wt.-%, based on the total composition, wherein the chemical blowing agent, if employed, is present in addition to the physical blowing agent.

8. The use of a polymeric foam according to claim 1 for filling cavities or hollow bodies, in particular in window or door profiles, or for the co-extrusion of at least two components.

9. Foam-filled hollow body, in particular in the form of a window or door profile, wherein it has at least one cavity which is filled with a polymeric foam according to claim 1.

10. Co-extrudate, comprising at least two components, wherein one component is a polymeric foam according to claim 1.

11. A method for producing a hollow body or cavity that is foamed with polymeric foam according to claim 1 as insulating material, wherein a composition comprising a polymer blend of a) polystyrene, polyphenylene oxide and/or polyphenyl ether, b) at least one blowing agent, and c) at least one nucleating agent, is fed to an extrusion apparatus, is activated therein under pressure, and upon discharge therefrom into the hollow body or the cavity is expanded with such a high volume expansion gradient that the insulation material formed by the expansion is filling the cross section of the hollow body or cavity instantaneously upon entry.

12. The method of claim 11, wherein the hollow body is a profile that is extruded from a plastic material, preferably polyvinyl chloride, and in a co-extrusion process the insulation material is introduced simultaneously with the formation of the plastic profile therein.

13. The method according to claim 11, wherein an extrusion apparatus with at least one screw conveyor is used and the extrusion apparatus is configured and the mechanical properties of the starting material are predetermined so that shear forces occur, which contribute at least to a thermal activation of the starting material.

14. The method according to claim 11, wherein an extrusion apparatus is used with a heating means and the heating means is operated such that it contributes at least to a thermal activation of the starting material.

15. The method according to claim 11, wherein the expansion process of the starting material during discharge from the extrusion apparatus is controlled by a special nozzle geometry, which imparts a predetermined cross-sectional shape to the insulating material flow.
